(19) United States
(12) Patent Application Publication
(10) Pub. No.: US 2011/0127090 A1
(43) Pub. Date: Jun. 2, 2011

(54) Weigh-In-Motion (WIM) Sensor

(76) Inventors: Krishna Vijayaraghavan, Sunnyvale, CA (US); Sean Pruden, Saint Louis Park, MN (US); Rajesh Rajamani, Saint Paul, MN (US)

(21) Appl. No.: 12/956,891

(22) Filed: Nov. 30, 2010

Related U.S. Application Data
(60) Provisional application No. 61/266,114, filed on Dec. 2, 2009.

(51) Int. Cl. G01G 19/03; G01G 19/00

(52) U.S. Cl. 177/133; 177/145

(57) ABSTRACT

In general, the disclosure is directed to techniques for sensing the weight of a load object passing over a measurement surface. In some examples, a weigh-in motion (WIM) sensor is provided that includes a first beam that exhibits a linear elastance function, and a second beam that exhibits a nonlinear elastance function. In additional examples, the WIM sensor may include a measurement circuit configured to generate information corresponding to a weight of the load object, a wireless transmission circuit configured to transmit the information to a receiving station, and an energy harvesting circuit configured to harvest an amount of energy from vehicle vibrations. The energy harvested may be sufficient to power the wireless transmission circuit. In further examples, a WIM system is provided that includes a sequence of sensors. Information from the sequence of sensors may be used to remove noise in the raw data due to vehicle vibration.

### TECHNICAL FIELD

This disclosure relates to sensors, and more particularly to weigh-in-motion sensors.

### BACKGROUND

Transportation agencies all around the country monitor traffic flow rates on most major highways. One technique commonly used to measure traffic flow rate are inductive loop detectors (ILDs). Other types of sensors include image processing based detectors and sound based systems. The flow rate information from such sensors is used to control ramp meters, identify congestion points, detect incidents and for a number of other applications.

An ILD consists of a big loop of metallic coil buried in the lane. This loop is connected to a station which powers the loop and processes the information obtained from the loop to determine if a vehicle passes over the sensor. The installation of the ILD involves cutting a large section of the roadway in each lane and therefore causes considerable traffic disruption. Owing to its operating principle, the ILD needs to be continuously powered resulting in considerable idle power loss.

### SUMMARY

In general, the disclosure is directed to techniques for sensing the weight of a load object passing over a measurement surface. In some examples, a weigh-in motion (WIM) sensor is provided that includes a first beam that exhibits a linear elastance function, and a second beam that exhibits a nonlinear elastance function. In additional examples, the WIM sensor may include a measurement circuit configured to generate information corresponding to a weight of the load object, a wireless transmission circuit configured to transmit the information to a receiving station, and an energy harvesting circuit configured to harvest an amount of energy from vehicle vibrations. The energy harvested may be sufficient to power the wireless transmission circuit. In further examples, a WIM system is provided that includes a sequence of sensors. Information from the sequence of sensors may be used to remove noise in the raw data due to vehicle vibration.

In one embodiment, the invention is directed to an apparatus that includes a first beam configured to deform when a load object passes over the apparatus, wherein the first beam exhibits a linear relationship between an amount of deformation and an amount of force applied to the first beam. The apparatus further includes a second beam configured to deform when the load object passes over the apparatus, wherein the second beam exhibits a nonlinear relationship between an amount of deformation and an amount of force applied to the first beam. The apparatus further includes an energy harvesting circuit configured to harvest energy from deformations of the second beam based on vibrations caused by the load object passing over the apparatus. The apparatus further includes a measurement circuit configured to generate an electrical parameter corresponding to a weight of the load object passing over the apparatus based on an amount of deformation of the first beam.

In another embodiment, the invention is directed to an apparatus that includes a beam configured to deform when a load object passes over the apparatus, wherein an amount of stiffness of the beam increases as an amount of force applied to the beam increases. The apparatus further includes a measurement circuit configured to generate an electrical parameter corresponding to a weight of the load object passing over the apparatus. The apparatus further includes a wireless transmission circuit configured to transmit the electrical parameter to a receiving station. The apparatus further includes an energy harvesting circuit configured to harvest an amount of energy from deformations of the beam that is sufficient to power the wireless transmission circuit.

In another embodiment, the invention is directed to a system that includes a sequence of sensing devices disposed along a measurement surface. Each sensing device within the sequence includes at least one beam that deforms when a vehicle passes over the respective sensing device, a measurement circuit configured to generate a respective electrical parameter corresponding to a weight of the load object passing over the respective at least one beam, and a wireless transmission circuit configured to wirelessly transmit the respective electrical parameter. The system further includes a central station configured to receive electrical parameters from the sensing devices within the sequence of sensing device, and process the electrical parameters to determine a weight of a vehicle passing over the sequence of sensing devices.

The details of one or more embodiments of the invention are set forth in the accompanying drawings and the description below. Other features, objects, and advantages of the invention will be apparent from the description and drawings, and from the claims.

### DETAILED DESCRIPTION

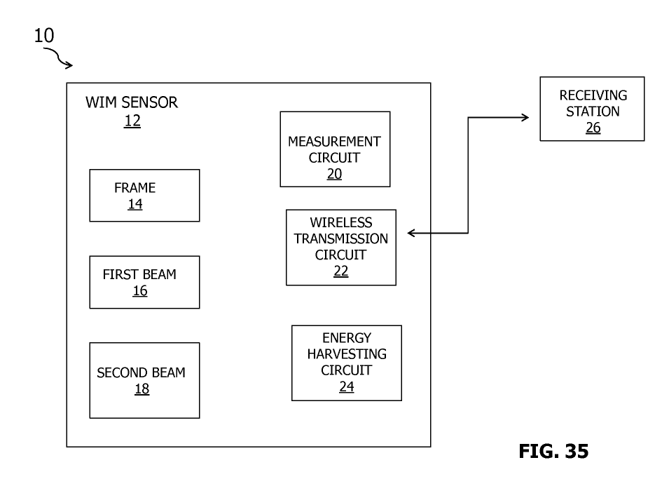

FIG. 35 is a block diagram of an example WIM system 10 according to this disclosure. WIM system 10 is configured to determine the weight of a load object (e.g., vehicle) passing over a measurement surface. The weight may be either a static weight or a dynamic weight. WIM system 10 includes WIM sensor 12 and receiving station 26.

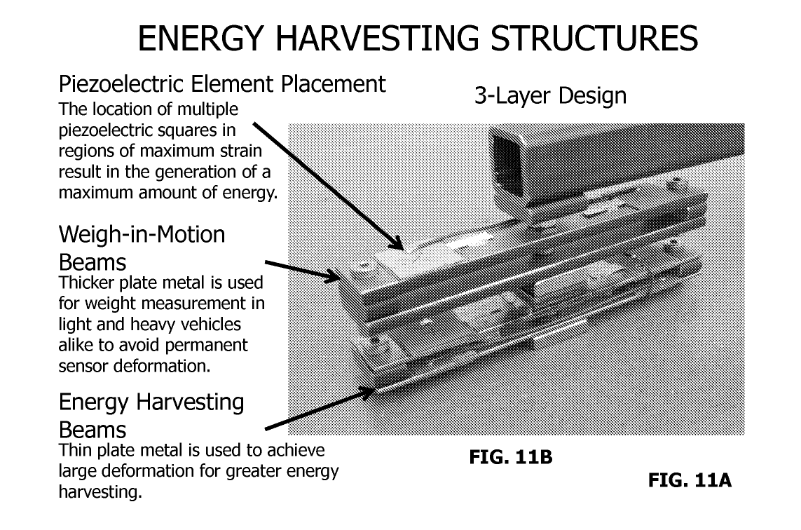

WIM sensor 12 is configured to generate information corresponding to the weight of a load object passing over the WIM sensor 12. In some examples, WIM sensor may be embedded into a measurement surface. The measurement surface may be a fixed measurement surface (e.g., a roadway) or a portable measurement surface (e.g., a raised surface with ramps on each end). WIM sensor 12 may include a frame 14, a first beam 16, a second beam 18, a measurement circuit 20, a wireless transmission circuit 22, and an energy harvesting circuit 24. In some examples, first beam 16 may correspond to the weigh-in motion beam illustrated in FIG. 11B, and second beam 18 may correspond to the energy harvesting beam illustrated in FIG. 11B.

Frame 14 is configured to apply force to the first beam and the second beam at one or more fixed locations on first beam 16 and/or second beam 18 in response to force applied by the load object to frame 14 when the load object passes over the frame. In some examples, frame 14 may be an elongated metallic beam with a major axis. When the load object passes over frame 14, the load object may cross the major axis of frame 14 at any location along the major axis (i.e., an unfixed location). The force applied to frame 14 at the crossing location is transferred to first beam 16 and/or second beam 18 at one or more fixed locations along the beams. By using a frame 14 that applies force to other beams at a fixed location, the effects of lateral displacement on strain measurements may be reduced and/or eliminated.

Frame 14 may be operatively coupled to first beam 16 and/or second beam 18 at one or more fixed locations along first beam 16 and/or second beam 18. In some examples, first beam 16, second beam 18, and any additional beams can be placed one on top of the other, thus transferring load sequentially from the top beam to the bottom beam. In some examples, frame 14 may be affixed or attached to one or both of first beam 16 and second beam 18. For example, frame 14 may be bolted to first beam 16 and/or second beam 18. In other examples, frame 14 may be welded to first beam 16 and/or second beam 18.

In some examples, frame 14 may have a linear elastance response. In general, the elastance response or function for an object may correspond to the elastic modulus for the object. The elastic modulus may be the ratio of stress to strain (i.e., stress divided by strain) for the object. Stress may refer to a measurement of an amount of force acting on an object per unit area. Strain may refer to a measurement of the relative change in a single dimension of an object (e.g., [((dimension length after deformation)−(dimension length prior to deformation)) divided by (dimension length prior to deformation)]).

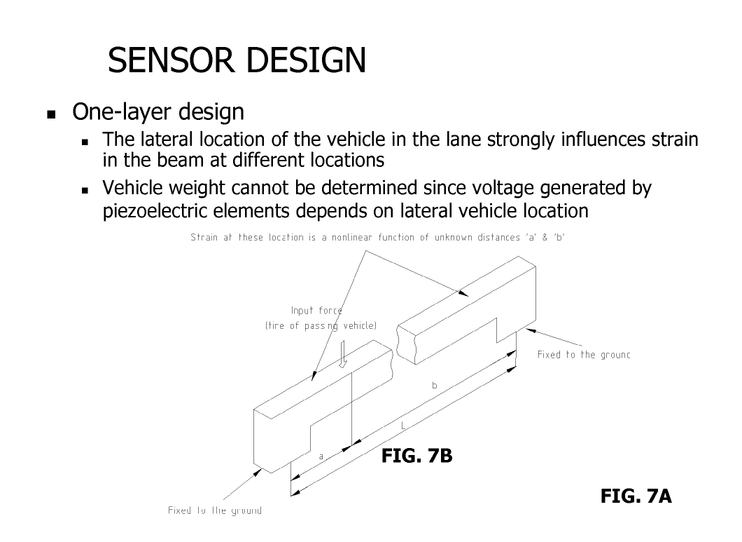

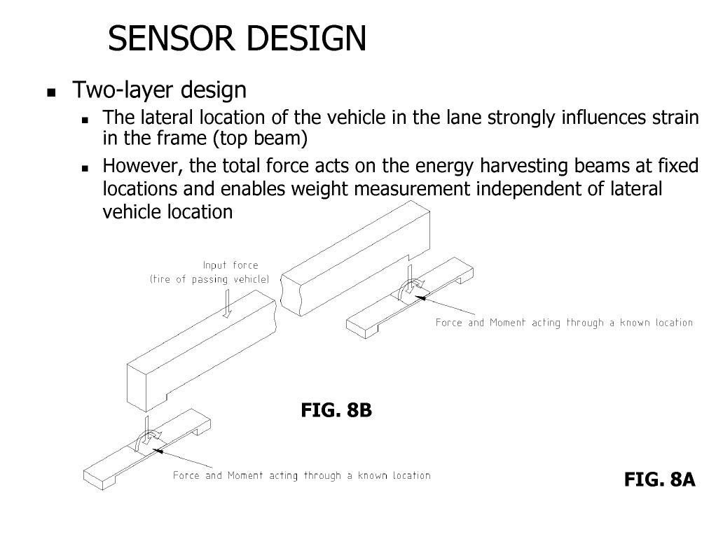

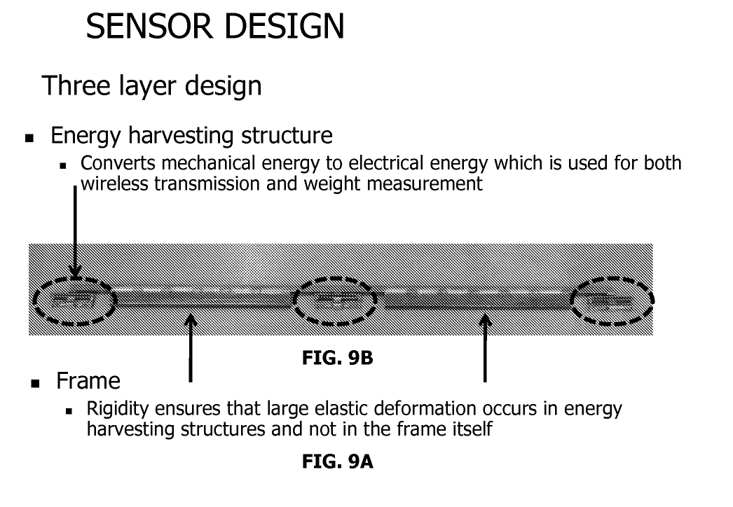

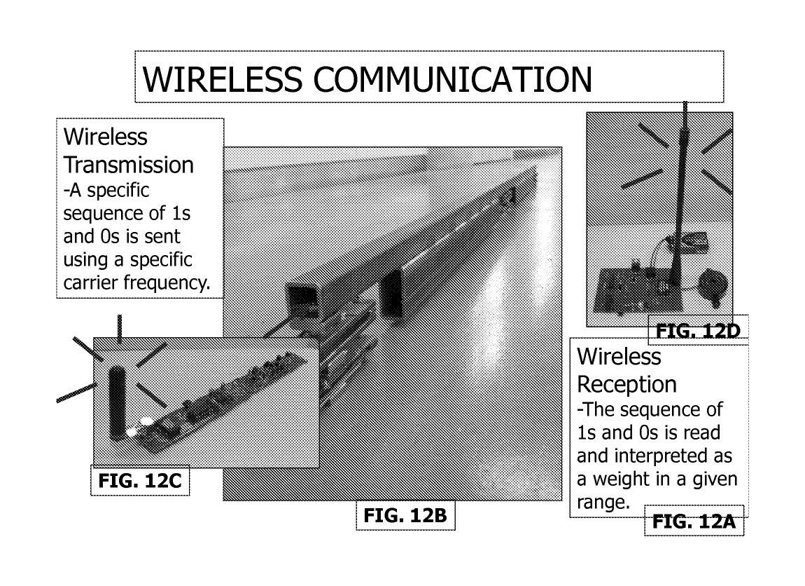

In some examples, frame 14 may correspond to any of the following: the beam illustrated in FIG. 7B, the top beam illustrated in FIG. 8B, the frame illustrated in FIG. 9B, and the top beam illustrated in FIGS. 11B and 12B. In additional examples, WIM sensor 12 may not include frame 14.

First beam 16 is configured to receive force applied to the beam at one or more fixed locations and deform in response to the applied force. The amount of deformation may vary based on the amount of applied force. In some examples, first beam 16 may have a linear elastance characteristic. For example, first beam 16 may exhibit a linear relationship between an amount of deformation and an amount of force applied to the first beam at the one or more fixed locations. The linear elastance function may be helpful for generating accurate weight data.

In some examples, first beam 16 may be a metallic beam. For example, first beam 16 may include two metallic plates that are affixed or attached to each other (e.g., via bolts or welding) at the ends of the plates. In some cases, the two metallic plates may be affixed at other locations. For example, the plates may be affixed at their midpoint in addition to or in lieu of being affixed at the ends of the plates. In additional examples, more or less metallic plates may be used to form the beam. In any case, the amount of deformation or deflection in the beam is related to the amount of deformation or deflection in the metallic plates.

The metallic plates used to form first beam 16 may be relatively thick compared to the metallic plates used to form second beam 18. In other words, the thickness of the metallic plates in first beam 16 may be greater than the thickness of the metallic plates in second beam 18. For example, the thickness of the metallic plates for first beam 16 may be, in some examples, in the range of approximately 3/16 of an inch to approximately ¾ of an inch. The overall thickness of first beam 16 may be, in some examples, in the range of approximately 1 inch to approximately 2 inches. The relative thickness of the metallic plates in first beam 16 allows for light and heavy vehicles to be measured while avoiding permanent sensor deformation. In addition, the linear elastic response of first beam 16 provides greater accuracy than the nonlinear response of second beam 18.

First beam 16 may be operatively coupled to frame 14 at one or more fixed locations along first beam 16. First beam 16 may also be operatively coupled to second beam 18 at one or more fixed locations along first beam 16. First beam 16 may be affixed or attached (e.g., bolted or welded) to second beam 18 using spacers. First beam 16 may be affixed (e.g., bolted or welded) to frame 14.

Second beam 18 is configured to receive force applied to the beam at one or more fixed locations and deform in response to the applied force. The amount of deformation may vary based on the amount of applied force. In some examples, second beam 18 may have a nonlinear elastance relationship. For example, second beam 18 may exhibit a nonlinear relationship between an amount of deformation and an amount of force applied to the first beam at the one or more fixed locations. The nonlinear elastance function may be helpful for increasing the amount of energy harvested for small and large vehicles.

In some examples, second beam 18 may be a metallic beam. For example, second beam 18 may include two metallic plates that are affixed or attached to each other (e.g., via bolts or welding) at the ends of the plates. In some cases, the two metallic plates may be affixed at other locations. For example, the plates may be affixed at their midpoint in addition to or in lieu of being affixed at the ends of the plates. In additional examples, more or less metallic plates may be used to form the beam. In any case, the amount of deformation or deflection in the beam is related to the amount of deformation or deflection in the metallic plates.

The metallic plates used to form second beam 18 may be relatively thin compared to first beam 16. In other words, the thickness of second beam 18 may be less than the thickness of first beam 18. For example, the thickness of the metallic plates in second beam 18 may be, in some examples, in the range of approximately 0.5 inches to approximately 1 inch. The overall thickness of second beam 18 may be, in some examples, in the range of approximately gauge 16 (e.g., approx. 0.065 inches) to approximately gauge 8 (e.g., approx. 0.165 inches). The relative thinness of metallic plates in second beam 18 allows for an increased amount of energy to be harvested from relatively light vehicles while the nonlinear response prevents permanent sensor deformation in response to relatively heavy vehicles.

In some examples, second beam 18 may have a stiffness function such that an amount of stiffness of second beam 18 increases as an amount of force applied to second beam 18 increases. For example, the beam may be designed to undergo a significant increase in stiffness after initial beam deflection under low stiffness. This technique may be used so as to harvest adequate energy from low-weight vehicles while at the same time ensuring that the deflection of the sensor beam does not become huge when a heavy-weight vehicle travels over the sensor. Due to the low initial stiffness of the sensor, a low-weight vehicle would also cause significant deflection resulting in adequate energy generation. After adequate beam deflection has been obtained, the beam's stiffness increases so that if the load were high (e.g., the load due to a heavy vehicle), the beam would not undergo excessive deformation or fail.

The type of stiffness behavior described above may be achieved by placing blocks or other blocking objects between the plates that make up second beam 18. For example, the blocking objects may be attached to one of the metallic plates on a surface that faces the other metallic plate. The thickness of the blocking objects may, in some examples, be less than the distance between the metallic plates. When the plates begin to deflect or deform, the stiffness of the plates and/or beam remains relatively low until the blocking objects come into contact with the other plate. When the blocking objects come into contact with the other plate, the stiffness of the plates and/or beam increases. In this manner, a nonlinear response for the beam may be achieved.

Stiffness may refer to the resistance of an object to deformation by an applied force. For example, the stiffness for a given force may be determined by taking the force applied to the object divided by the displacement produced by the force. Thus, for the same amount of force, an object with a higher amount of stiffness will have less displacement (e.g., deformation) and an object with a lesser amount of stiffness will have a greater displacement (e.g., deformation).

Second beam 18 may be operatively coupled to frame 14 at one or more fixed locations along second beam 18. Second beam 18 may also be operatively coupled to first beam 16 at one or more fixed locations along second beam 18. Second beam 18 may be affixed or attached (e.g., bolted or welded) to first beam 16 using spacers. Second beam 18 may be affixed (e.g., bolted or welded) to frame 14.

Measurement circuit 20 is configured to generate information indicative of an amount of strain of deformation of first beam 16 and/or second beam 18. In some examples, the information may be an electrical parameter (e.g. voltage, charge or current) that corresponds to the amount of strain or deformation of one or more of the beams. The electrical parameter may correspond to a weight of the load object passing over the sensor. In other examples, the information may be a processed analog or digital value corresponding to the weight of the load object.

In some examples, measurement circuit 20 may include one or more piezoelectric elements that are attached to or disposed on first beam 16 and/or second beam 18. Each of these piezoelectric elements is configured to adjust an electrical parameter (e.g. voltage or current) in response to an amount of deformation of the beam to which the element is attached. The amount of deformation may correspond to the strain of the beam that occurs due to force being applied to the beam when a load object passes over the beam. In some examples, the piezoelectric elements on the first beam are used solely for the purpose of weight measurement, and the piezoelectric elements on the second beam are used for energy harvesting. Additional beams (similar to the second beam) may also be used for energy harvesting to increase the amount of energy harvested.

In some examples, the piezoelectric elements may be electrically coupled to circuitry that performs additional processing. For example, circuitry that performs additional processing may include one or more diodes and one or more capacitors that can measure the charge generated. The charge or voltage generated by the piezo is measured and serves as a measure of weight.

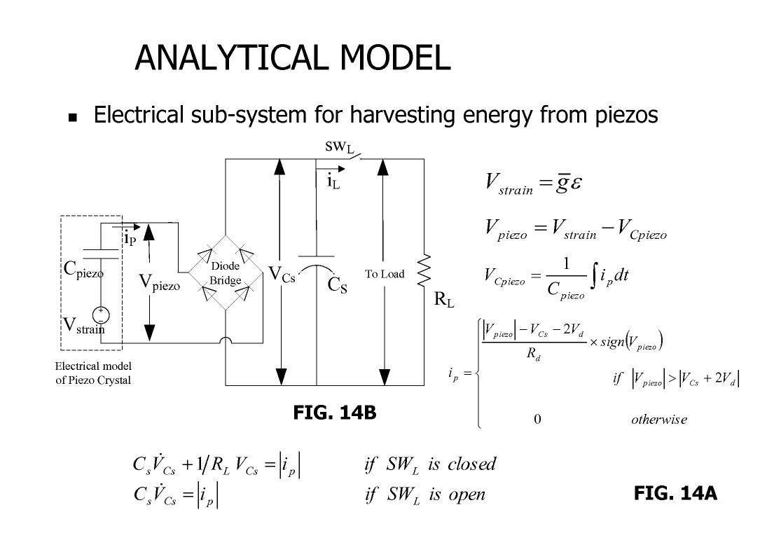

In additional examples, one or more of the piezoelectric elements may be electrically coupled to energy harvesting circuit 24 and/or wireless transmission circuit 22. In some examples, the piezoelectric elements attached to second beam 18 are used for energy harvesting, and the piezoelectric elements attached to first beam 16 are connected to a capacitor in the circuit (e.g., Load Capacitor or Cs in FIG. 14B) through a diode (e.g., diode bridge in FIG. 14B). Load Capacitor may have a voltage corresponding to the weight of the vehicle. In some examples, the voltage may not be directly proportional to the weight of the vehicle. When sufficient power has been harvested (e.g., after a vehicle has passed over the sensor), in some examples, a micro processor in measurement circuit 20 measures the load capacitor voltage (or charge), encodes this information, and sends it to the wireless transmission circuit 22 to transmit to receiving station 26.

In some examples, the piezoelectric elements may include piezoelectric sensors or piezoelectric crystals. In other examples, the piezoelectric elements may include any element that adjusts an electrical parameter based on the strain or deformation of a beam. In some examples, the piezoelectric elements may correspond to the piezoelectric elements illustrated in FIG. 11B.

Wireless transmission circuit 22 is configured to wirelessly transmit the information generated by measurement circuit 20 to receiving station 26. Wireless transmission circuit 22 may, in some examples, transmit the information as digital data (e.g., a sequence of ones and zeros) at a particular carrier frequency.

In some examples, wireless transmission circuit 20 may not require the use of batteries or external power sources to operate. Instead, in such examples, wireless transmission circuit 20 may rely upon energy produced by energy harvesting circuit 24.

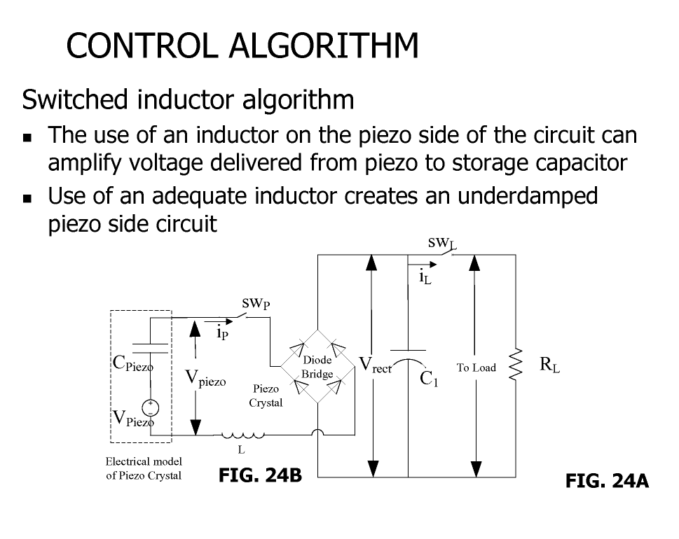

Energy harvesting circuit 24 is configured to extract or harvest energy from vibrations caused by the load object passing over the sensor. Energy harvesting circuit 24 may correspond to the circuit shown in FIG. 14B or the circuit shown in FIG. 24B. In some examples, energy harvesting circuit may harvest energy from vibrations that is sufficient to power wireless transmission circuit 22. In additional examples, energy harvesting circuit may harvest energy from vibrations that is sufficient to power wireless transmission circuit 22 and measurement circuit 20.

In some examples, energy harvesting circuit 24 may store energy in a Load Capacitor (e.g., Cs in FIG. 14B). In some cases, the Load Capacitor used for energy harvesting may be the same Load Capacitor that is used for weight measurements in measurement circuit 20. Thus, measurement circuit 20 and energy harvesting circuit 24 may, in some examples, share some or all of their components.

Receiving station 26 is configured to receive information relating to the weight of a load object passing over sensor 12. In some examples, the information may be raw data, such as, e.g., electrical parameters corresponding to an amount of strain or deformation of one or more beams. In other examples, the information may be a processed analog or digital value corresponding to the weight of the load object.

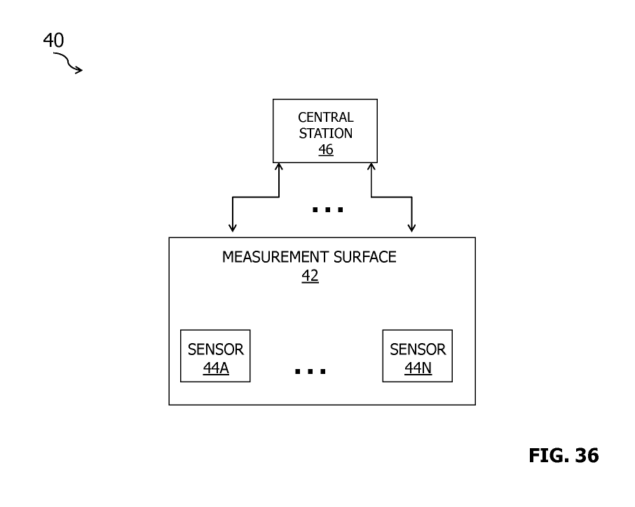

Receiving station 26 may include one or more programmable processors to perform subsequent processing on the received information to determine the weight of the load object passing over the sensor. In some examples, receiving station 26 may correspond to the central station and/or perform some of the same algorithms of the central station discussed below with respect to FIG. 36.

Although WIM sensor 12 in FIG. 35 is illustrated with two beams 16, 18 any number of additional beams may be added to the sensor without departing from the scope of this disclosure. For examples, one or more additional energy harvesting beams (i.e., nonlinear elastance) may be added to the sensor. In some examples, first beam 16, second beam 18, and any additional beams may be placed one on top of the other, thus transferring load sequentially from the top beam to the bottom beam.

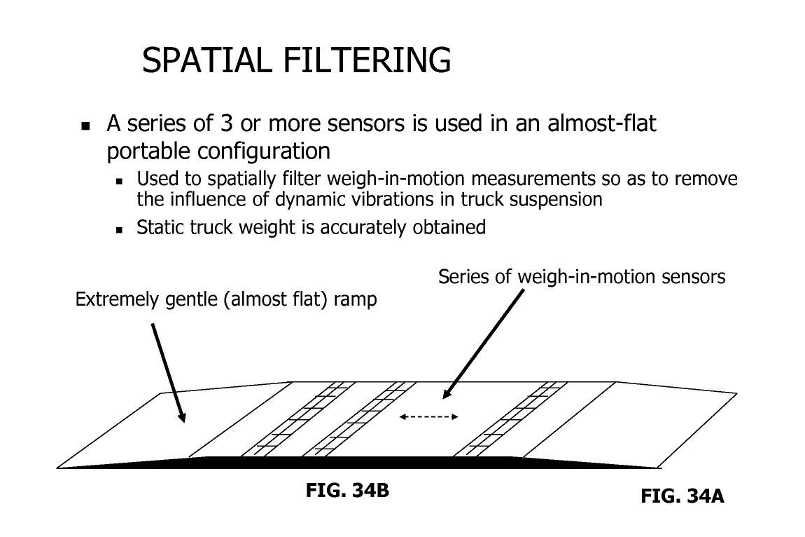

FIG. 36 is a block diagram of a WIM sensor system 40 in accordance with this disclosure. WIM sensor system 40 includes measurement surface 42 and central station 46. Measurement surface 42 may be a fixed measurement surface (e.g., a roadway) or a portable measurement surface (e.g., a raised surface with ramps on each end, see FIG. 34B). Measurement surface 42 may include a plurality of sensing devices 44A-44N disposed on or embedded within measurement surface. Each of the plurality of sensing devices 44A-44N may correspond to WIM sensor 12 discussed above with respect to FIG. 35. In some examples, the plurality of sensing devices 44A-44N may include at least four sensing devices.

A large source of error in existing WIM systems arises from vehicle vibrations induced by road roughness. As the heavy truck experiences vibrations in its chassis, these vibrations cause the load on the pavement sensor to deviate from the static weight of the truck. In some examples, the influence of vehicle vibrations may be removed by using a series of consecutive sensors installed in the road and then using spatial filters to remove the error due to vibrations. Information from all the series of sensors may then used to calculate the static weight of the vehicle accurately. The use of such a series of sensors may be enabled by the low unit cost of each sensor.

Central station 46 is configured to receive information relating to the weight of a load object passing over measurement surface 42, and to process the electrical parameters to determine a weight of a vehicle passing over the sequence of sensing devices 44A-44N. In some examples, the information may be raw data, such as, e.g., electrical parameters corresponding to an amount of strain or deformation of one or more beams. In other examples, the information may be partially-processed analog or digital value corresponding to the weight of the load object.

Central station 46 may include one or more programmable processors that are configured to perform a spatial filtering algorithm. The spatial filtering algorithm is designed to remove the effects of vehicle vibration on the raw data as the vehicle crosses measurement surface 42. The spatial filtering algorithm may include, for example, techniques for calculating a weighted average of the electrical parameters, calculating a moving average of the electrical parameters, performing a curve fitting algorithm, performing adaptive estimation, modeling vehicle vibrations, and any other statistical processing that can be performed to remove effects due to vehicle vibration.

In some examples, central station 46 may form a signal from the electrical parameters received from the sensing devices 44A-44N, and determine a bias of the signal corresponding to the electrical parameters. The bias of the signal may correspond to the weight of the vehicle. In other words, the signal corresponding to the electrical parameters may be considered to be a noisy signal that includes information of interest (e.g., weight information) and noise (e.g., offsets due to vibration). By determining the bias of the signal, the signal of interest may be able to be extracted from the noisy signal. In additional examples, central station 46 may calculate an amplitude or frequency of the signal corresponding to the electrical parameters.

In addition to the weight of the vehicle, which in some examples is determined from the bias, the total load which may include the weight and superimposed vibrations can also be obtained. The total load is useful in studies of how the pavement life is related to loads. The amplitude provides the dynamic load. The weight plus dynamic load provides the total load.

In some examples, sensing devices 44A-44N may be arranged in a sequence along a major axis of measurement surface 42. In such examples, a length between a first sensing device along the axis and a last sensing device along the axis may be adjusted to capture a desired portion of the vibration waveform. For example, the length between the first and last sensing device may be configured such that entire cycle of the vehicle vibration is captured. In other examples, the length between the first and last sensing device may be configured such that a fraction of the cycle of the vehicle vibration is captured. In some examples, the length may be configured within the range of 1 to 3 meters.

Example WIM sensors designed in accordance with this disclosure may include a thin beam-like device (e.g., a thin beam). In some examples, the beam may be approximately 6 feet long, 1 inch wide and 3 inches high. The beam-like device may be installed in the roadway by saw-cutting a thin slot in the road and then sealing the beam-like device inside this slot in the pavement.

The WIM sensor systems described herein may enable accurate measurement of the weight of vehicles that pass over the road at the location of the sensor. The WIM sensor systems of this disclosure may also transmit wireless signals representative of the weight measurement data to a remote receiver. In some examples, the remote receiver may be greater than 500 feet away from the sensor system.

The WIM sensor system described herein may be used to measure the weights of vehicles traveling over the road at the sensor location. The weight measurements in traditional WIM systems may subject to errors due to vehicle vibrations (e.g., tire vibrations) caused by the tires passing over the roadway. The novel WIM sensor system described in this disclosure provide may reduce and/or eliminate errors caused by vehicle vibrations.

In some examples, the weight measurement data produce by the WIM sensors can be wirelessly transmitted without causing the vehicles to slow down and without causing disruptions in traffic. For example, the developed system can be used to measure if a heavy truck is over the legal weight limit, exceeding the allowable load for a particular road. This can be used to protect a road pavement from damage and to charge a penalty to the offending vehicle. The developed system can also be used to create a toll-collection system in which heavy trucks can be charged toll according to their total weight.

The WIM sensors described herein may be able to be produced at a lower cost than that which is required for traditional WIM sensors. For example, traditional weigh-in-motion (WIM) sensor systems may cost over $20,000 per sensor. The sensor described herein may, in some examples, be produced at a cost of less than $200.

Traditional WIM sensor systems are typically wired and require an external power source. Other WIM sensor systems that utilize wireless transmission require a battery for operation. However, a WIM sensor designed in accordance with this disclosure may be both battery-less and wireless.

The WIM sensors, in some examples, may be developed at a low cost and may be compact in size allowing such sensors to be widely deployed widely on all highways. In some examples, the cost of the WIM sensors described herein may be comparable to that of an inductive loop detector (ILD) that only measures traffic flow rate and cannot measure vehicle weight. Compared to an ILD, however, the WIM sensors described herein can measure traffic flow rate, provide vehicle classification by counting the number of axles on each passing vehicle and/or measure the weight of the passing vehicle. Thus, the battery-less wireless sensors described herein may provide more information about each passing vehicle as compared to ILD sensors. Further, the installation of the WIM sensors, in some examples, may require no external wiring. Therefore, the WIM sensors described herein may be easier to install as compared to an ILD sensors.

A large source of error in existing WIM systems arises from vehicle vibrations induced by road roughness. As the heavy truck experiences vibrations in its chassis, these vibrations cause the load on the pavement sensor to deviate from the static weight of the truck. In some examples, the influence of vehicle vibrations may be removed by using a series of consecutive sensors installed in the road and then using spatial filters to remove the error due to vibrations. Information from all the series of sensors may then used to calculate the static weight of the vehicle accurately. The use of such a series of sensors may be enabled by the low unit cost of each sensor.

In some examples, at least one of the beams within the WIM sensor may include a nonlinear elastance response to loads. For example, the beam may be designed to undergo a significant increase in stiffness after initial beam deflection under low stiffness. This technique may be used so as to harvest adequate energy from low-weight vehicles while at the same time ensuring that the deflection of the sensor beam does not become huge when a heavy-weight vehicle travels over the sensor. Due to the low initial stiffness of the sensor, a low-weight vehicle would also cause significant deflection resulting in adequate energy generation. After adequate beam deflection has been obtained, the beam's stiffness increases so that if the load were high (from a heavy vehicle), the beam would not undergo excessive deformation or fail.

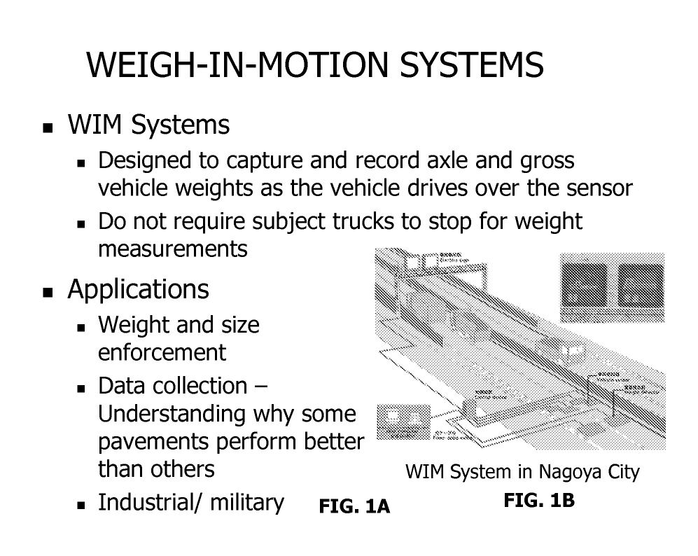

FIG. 1A is a slide describing features and applications of example weigh-in motion (WIM) systems in accordance with this disclosure.

FIG. 1B is a conceptual diagram illustrating a weigh-in motion system that does not use wireless communication.

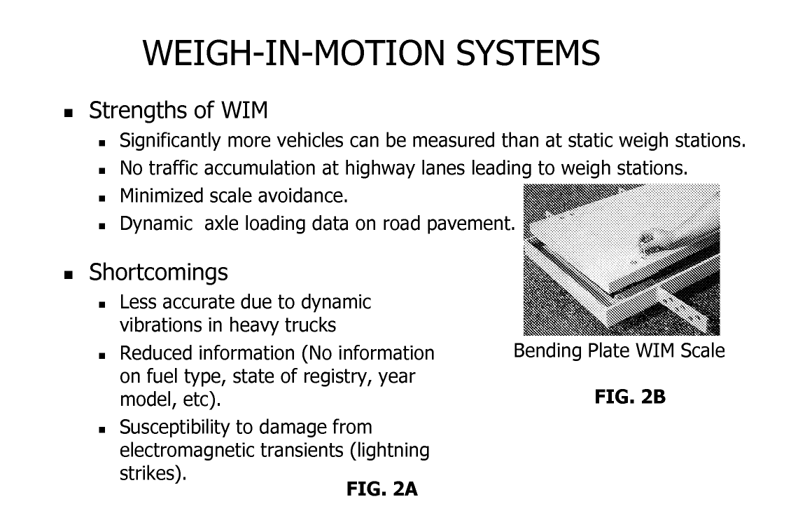

FIG. 2A is a slide describing one or more advantages of example WIM systems in accordance with this disclosure.

FIG. 2B is a photograph illustrating a bending plate WIM scale.

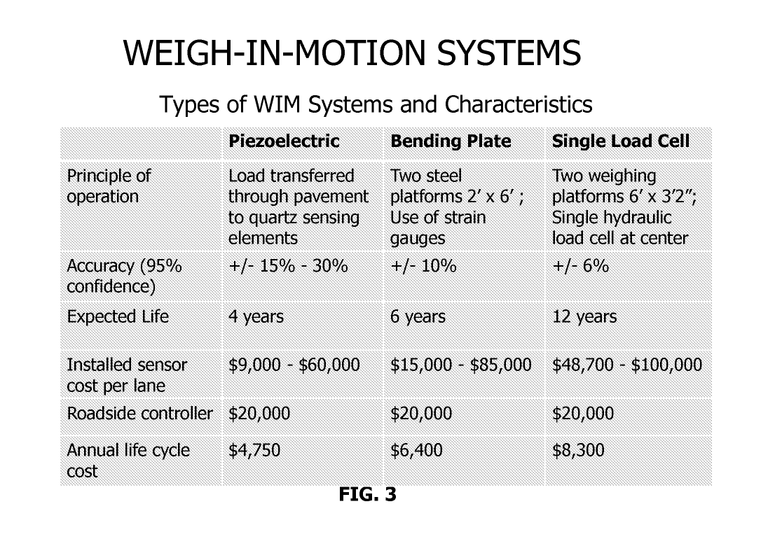

FIG. 3 is a chart illustrating different types of WIM systems and their characteristics.

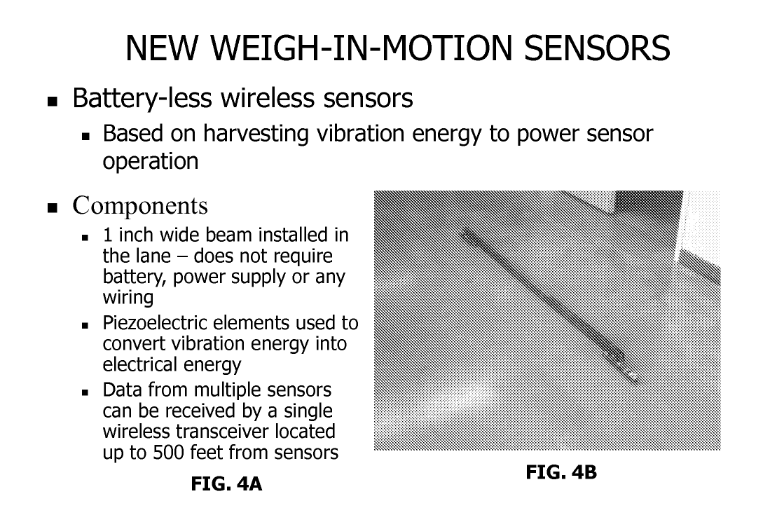

FIG. 4A is a slide describing an example battery-less wireless WIM sensor in accordance with this disclosure.

FIG. 4B is a photograph of the example WIM sensor described in FIG. 4A.

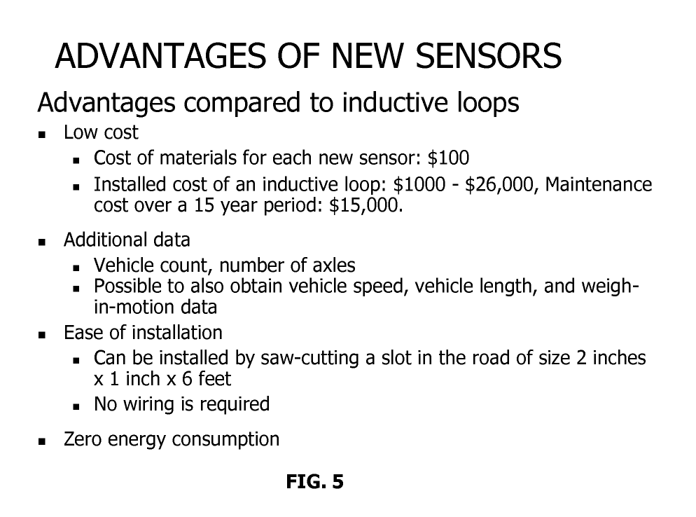

FIG. 5 is a slide discussing one or more advantages that may result from using an example WIM sensor designed in accordance with this disclosure compared to inductive loop technology.

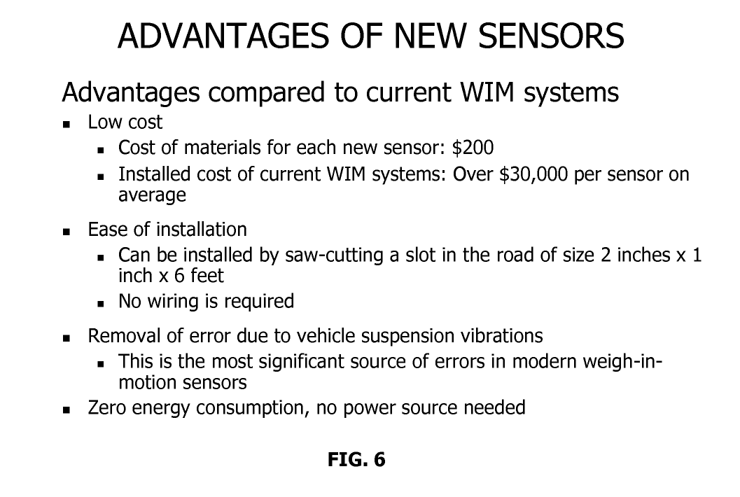

FIG. 6 is a slide discussing one or more advantages that may result from using an example WIM sensor designed in accordance with this disclosure compared to conventional WIM technology.

FIG. 7A is a slide discussing an example one-layer WIM sensor system.

FIG. 7B is a perspective diagram illustrating an example one-layer WIM system.

FIG. 8A is a slide discussing an example two-layer WIM sensor system.

FIG. 8B is a perspective diagram illustrating an example two-layer WIM system.

FIG. 9A is a slide discussing an example three-layer WIM sensor system in accordance with this disclosure.

FIG. 9B is a photograph illustrating an example three-layer WIM system in accordance with this disclosure.

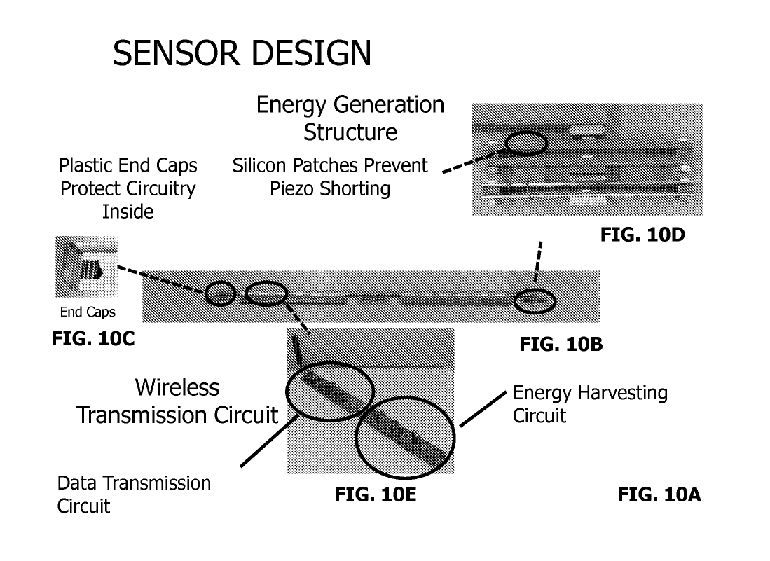

FIG. 10A is slide discussing the example three-layer WIM system of FIG. 9B in greater detail.

FIG. 10B is a photograph illustrating the example three-layer WIM system of FIG. 9B.

FIG. 10C is a photograph illustrating the end caps of the example three-layer WIM system of FIG. 10B in greater detail.

FIG. 10D is a photograph illustrating the energy generation structure of the example three-layer WIM system of FIG. 10B in greater detail.

FIG. 10E is a photograph illustrating the wireless transmission circuit and the energy harvesting circuit of the example three-layer WIM system of FIG. 10B in greater detail.

FIG. 11A is slide discussing the energy harvesting structures and the WIM structures of an example three-layer WIM system in accordance with this disclosure. The example three-layer WIM system may correspond to the three-layer WIM system illustrated in FIG. 9B.

FIG. 11B is photograph illustrating the energy harvesting structures and the WIM structures described in FIG. 11A.

FIG. 12A is a slide describing the wireless communication features of an example three-layer WIM system in accordance with this disclosure.

FIG. 12B is a photograph illustrating the three-layer WIM system described in FIG. 12A.

FIG. 12C is a photograph illustrating example wireless transmission circuitry for the three-layer WIM system shown in FIG. 12B.

FIG. 12D is a photograph illustrating example wireless reception circuitry for the three-layer WIM system shown in FIG. 12B.

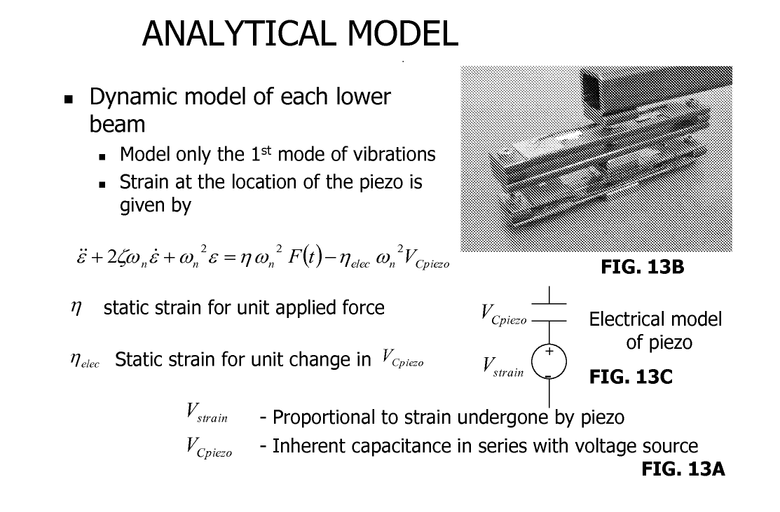

FIG. 13A is a slide describing an analytical model that may be used for modeling the lower two beams in an example three-layer WIM system in accordance with this disclosure.

FIG. 13B is a photograph illustrating the three-layer WIM system with respect to which an analytical model is described in FIG. 13A.

FIG. 13C is a circuit diagram illustrating an example electrical model of a piezoelectric element that may be used within the three-layer WIM system of FIG. 13B.

FIG. 14A is a slide describing an analytical model for modeling the electrical sub-system used for harvesting energy from the piezoelectric elements.

FIG. 14B is a circuit diagram that illustrates an analytical model for the electrical sub-system used for harvesting energy from the piezoelectric elements.

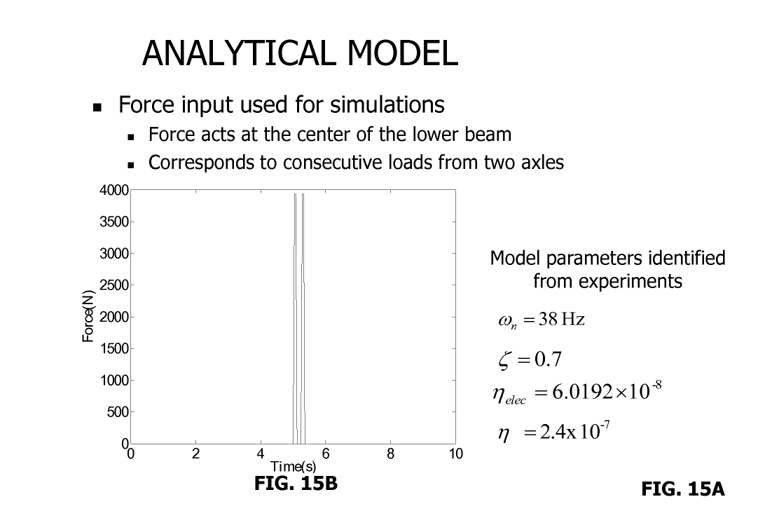

FIG. 15A is a slide describing the forced inputs used to simulate the analytical model described with respect to FIGS. 13A-14B. FIG. 15A also describes the model parameters identified from experiments.

FIG. 15B is a chart illustrating a magnitude of force applied to the inputs of the analytical model over a given time period.

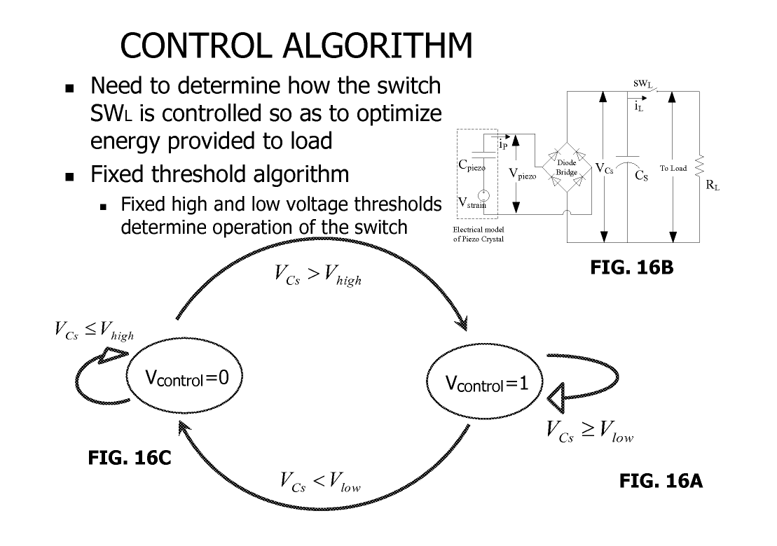

FIG. 16A is a slide describing an example fixed threshold control algorithm for use with an example three-layer WIM system in accordance with this disclosure.

FIG. 16B is a circuit diagram that illustrates an analytical model for the electrical sub-system used for harvesting energy from the piezoelectric elements.

FIG. 16C is a state transition diagram that indicate the states of the fixed threshold control algorithm and the conditions for a state transition to occur.

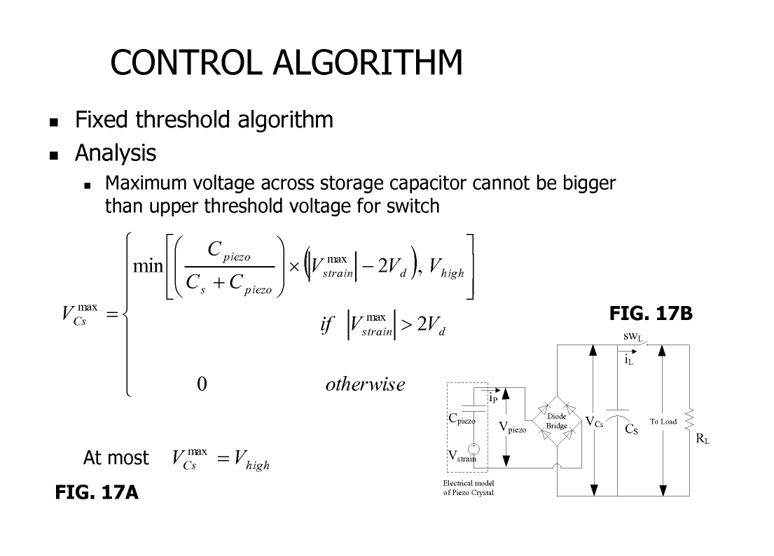

FIG. 17A is a slide providing mathematical analysis of the fixed threshold control algorithm described with respect to FIG. 16A.

FIG. 17B is a reproduction of the circuit diagram shown in FIG. 16B.

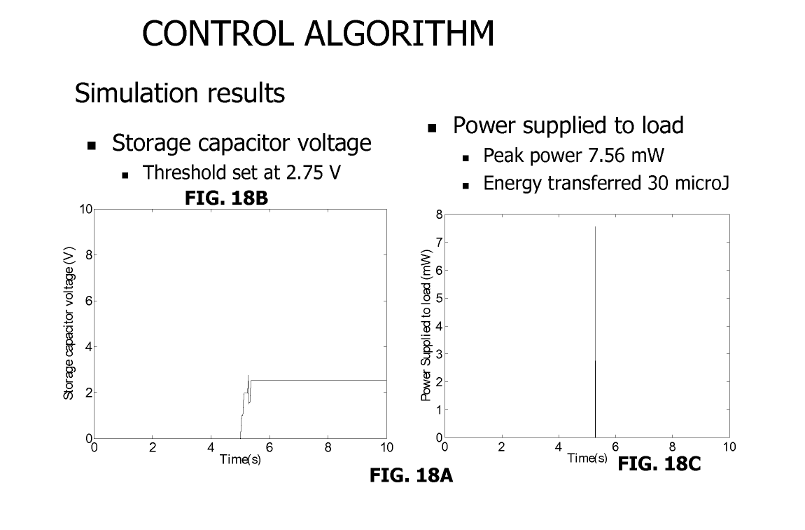

FIG. 18A is slide describing the simulation results for the fixed threshold control algorithm described above with respect to FIGS. 16A-17B.

FIG. 18B is a chart illustrating the storage capacitor voltage over a given time period during the simulation.

FIG. 18C is a chart illustrating the power supplied to the load over a given time period during the simulation.

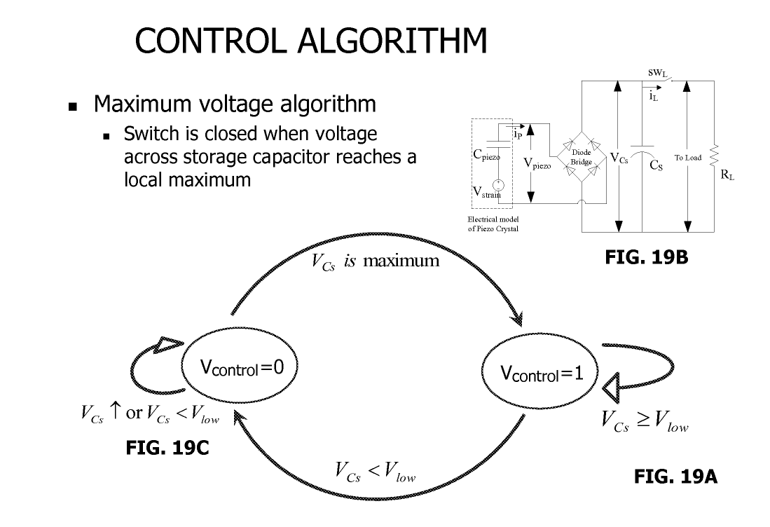

FIG. 19A is a slide describing an example maximum voltage control algorithm for use with an example three-layer WIM system in accordance with this disclosure.

FIG. 19B is a circuit diagram that illustrates an analytical model for the electrical sub-system used for harvesting energy from the piezoelectric elements.

FIG. 19C is a state transition diagram that indicate the states of the maximum voltage control algorithm and the conditions for a state transition to occur.

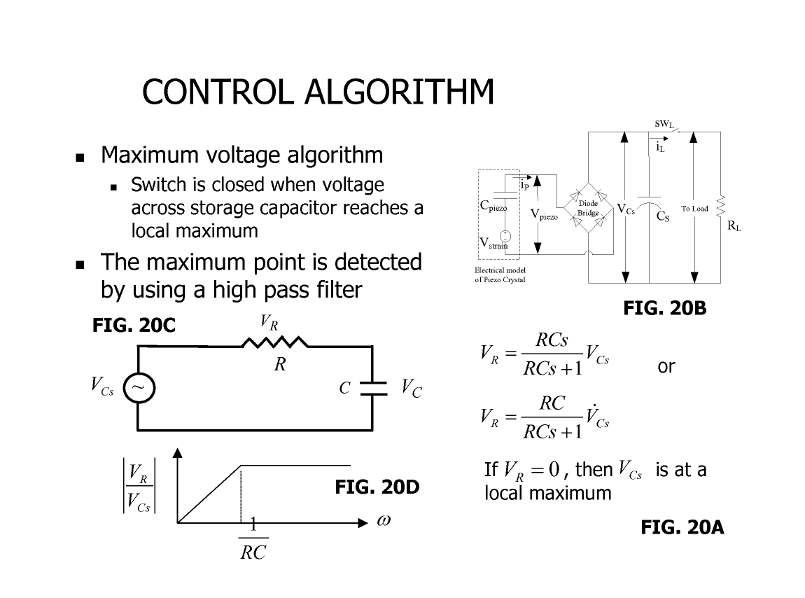

FIG. 20A is a slide describing how to detect a maximum voltage across the storage capacitor for use in the maximum voltage control algorithm described with respect to FIGS. 19A-19C.

FIG. 20B is a reproduction of the circuit diagram shown in FIG. 19B.

FIG. 20C is a circuit diagram of a high-pass filter that may be used to detect the maximum voltage point across the storage capacitor.

FIG. 20D is a chart illustrating the transfer characteristic of the high-pass filter verses frequency.

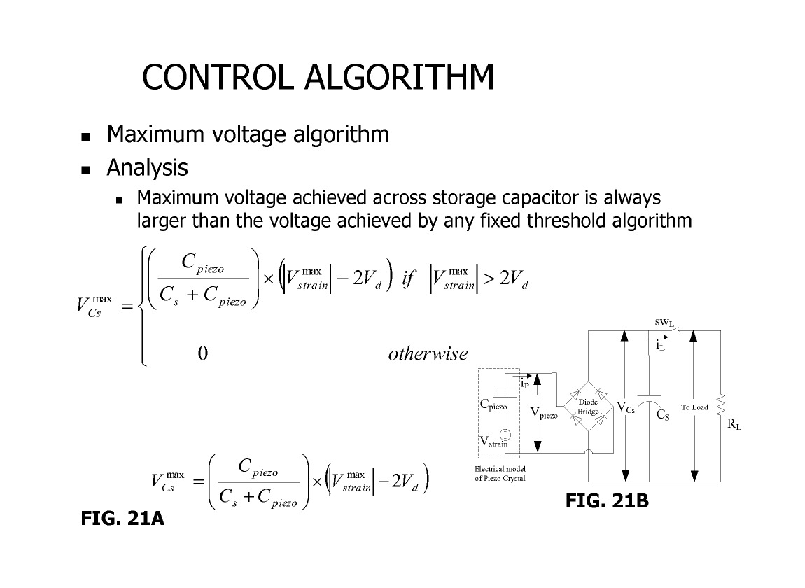

FIG. 21A is a slide providing mathematical analysis of the maximum voltage control algorithm described with respect to FIGS. 19A-20D.

FIG. 21B is a reproduction of the circuit diagram shown in FIG. 19B.

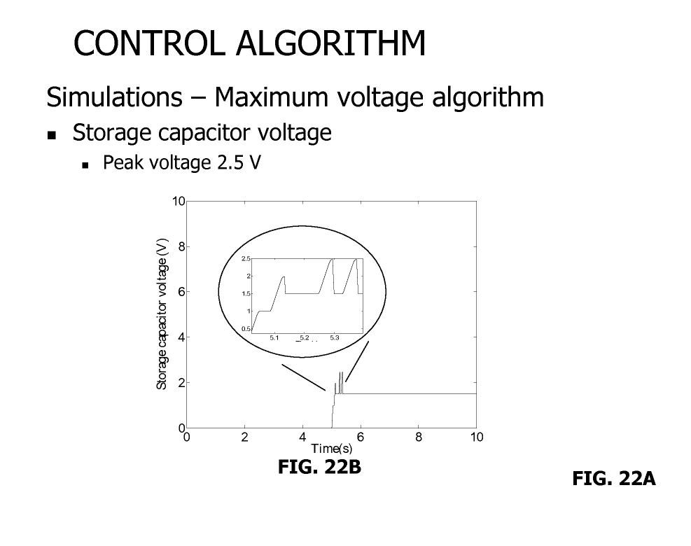

FIG. 22A is slide describing the simulation results for the maximum voltage control algorithm described above with respect to FIGS. 19A-21B.

FIG. 22B is a chart illustrating the storage capacitor voltage over a given time period during the simulation.

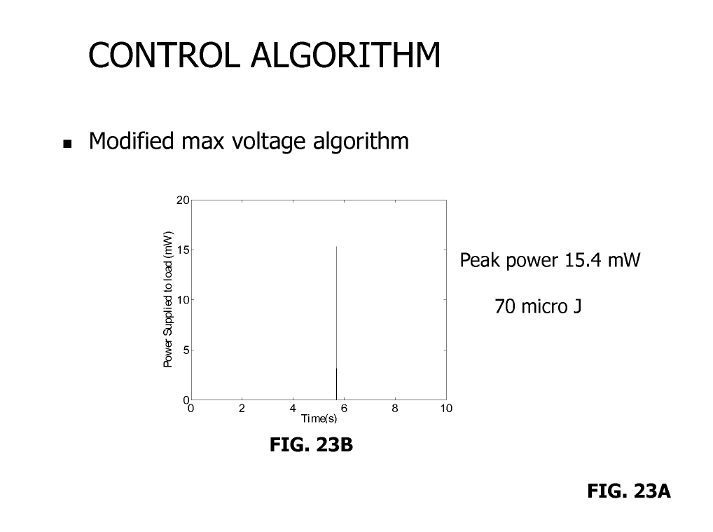

FIG. 23A is slide describing the simulation results for an example modified maximum voltage control algorithm for use with an example three-layer WIM system in accordance with this disclosure. The modified maximum voltage algorithm is similar to the maximum voltage algorithm except that the switch is closed only when a maximum of the voltage is detected to be larger than a threshold.

FIG. 23B is a chart illustrating the power supplied to the load over a given time period during the simulation.

FIG. 24A is a slide describing an example switched inductor control algorithm for use with an example three-layer WIM system in accordance with this disclosure.

FIG. 24B is a circuit diagram that illustrates an analytical model for the electrical sub-system used for harvesting energy from the piezoelectric elements. The circuit diagram includes an inductive element (L).

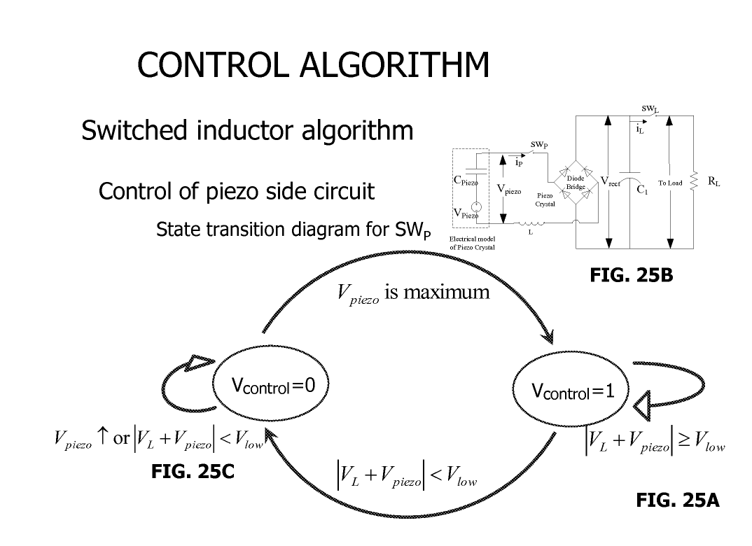

FIG. 25A is a slide describing the control of the piezo side of the circuit in accordance with the switched inductor control algorithm of FIG. 24A.

FIG. 25B is a reproduction of the circuit diagram shown in FIG. 24B.

FIG. 25C is a state transition diagram that indicate the states of the switched inductor control algorithm for the piezo side of the circuit and the conditions for a state transition to occur.

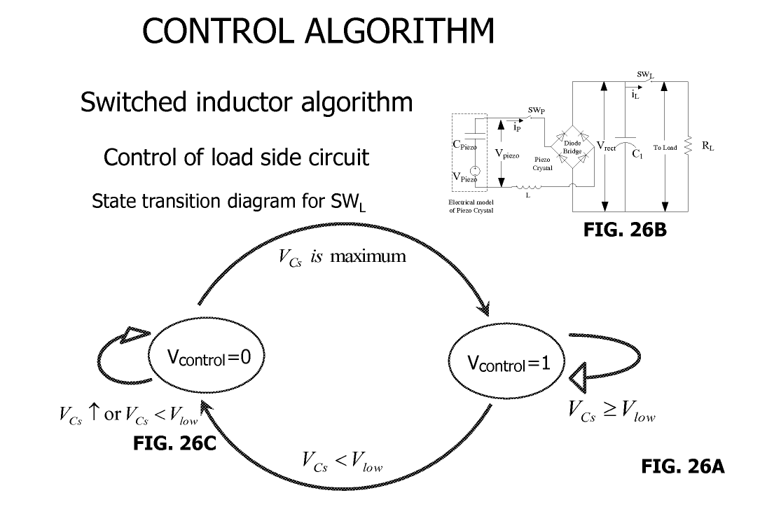

FIG. 26A is a slide describing the control of the load side of the circuit in accordance with the switched inductor control algorithm of FIG. 24A.

FIG. 26B is a reproduction of the circuit diagram shown in FIG. 24B.

FIG. 26C is a state transition diagram that indicate the states of the switched inductor control algorithm for the load side of the circuit and the conditions for a state transition to occur.

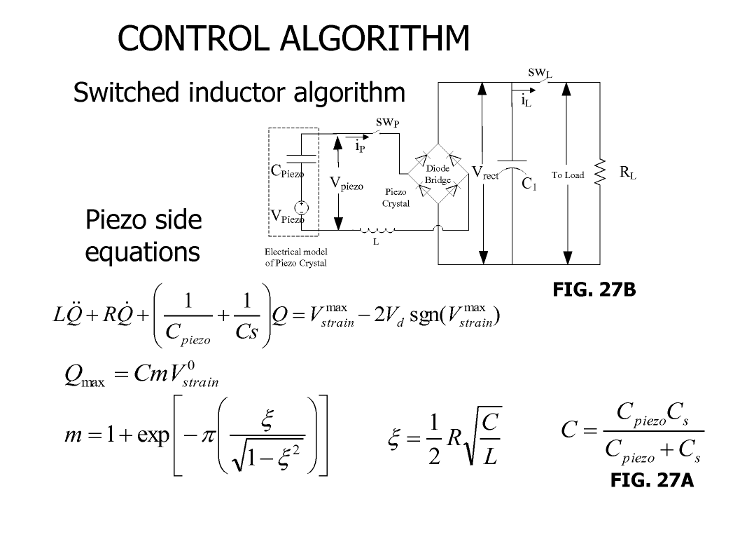

FIG. 27A is a slide providing equations for the piezo side of the circuit shown in FIG. 24B for use with the switched inductor control algorithm.

FIG. 27B is a reproduction of the circuit diagram shown in FIG. 24B.

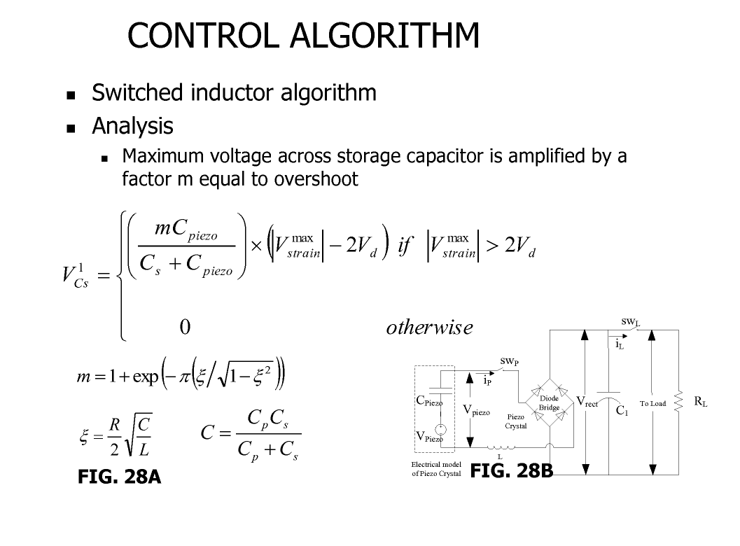

FIG. 28A is a slide providing mathematical analysis of the switched inductor control algorithm described with respect to FIGS. 24A-27B.

FIG. 28B is a reproduction of the circuit diagram shown in FIG. 24B.

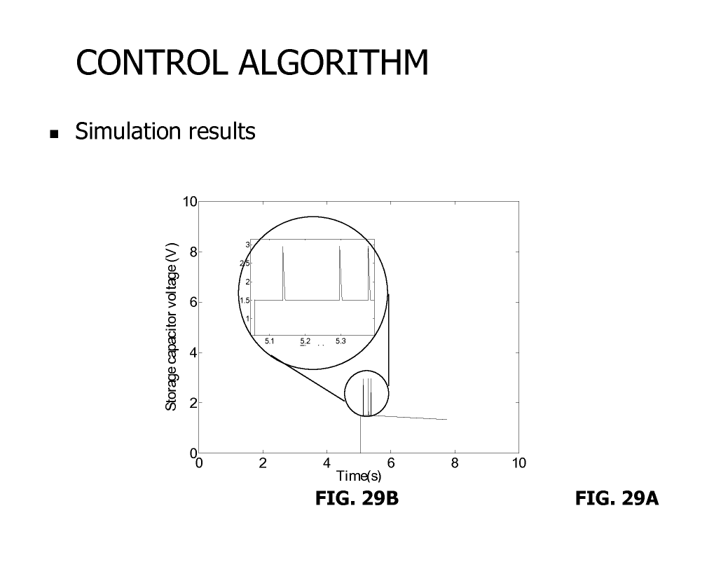

FIG. 29A is slide describing the simulation results for the switched inductor control algorithm described above with respect to FIGS. 24A-28B.

FIG. 29B is a chart illustrating the storage capacitor voltage over a given time period during the simulation.

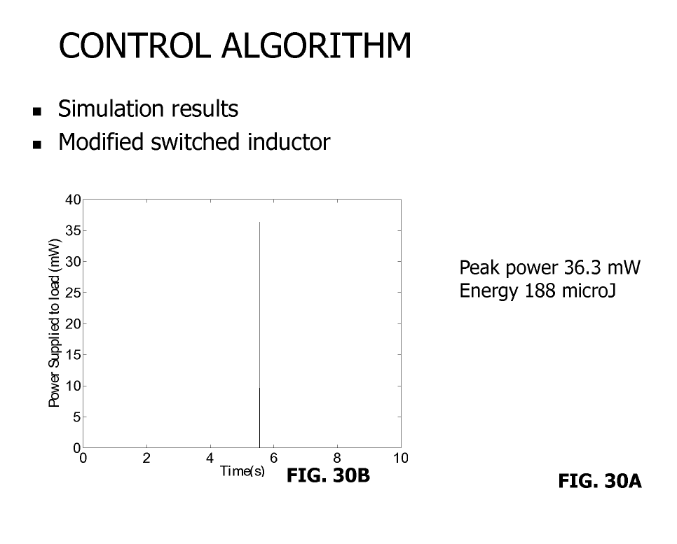

FIG. 30A is slide describing the simulation results for an example modified maximum voltage control algorithm for use with an example three-layer WIM system in accordance with this disclosure. The modified switched inductor algorithm is similar to the switch inductor algorithm except that the switch is closed only when a maximum of the voltage is detected to be larger than a threshold.

FIG. 30B is a chart illustrating the power supplied to the load over a given time period during the simulation.

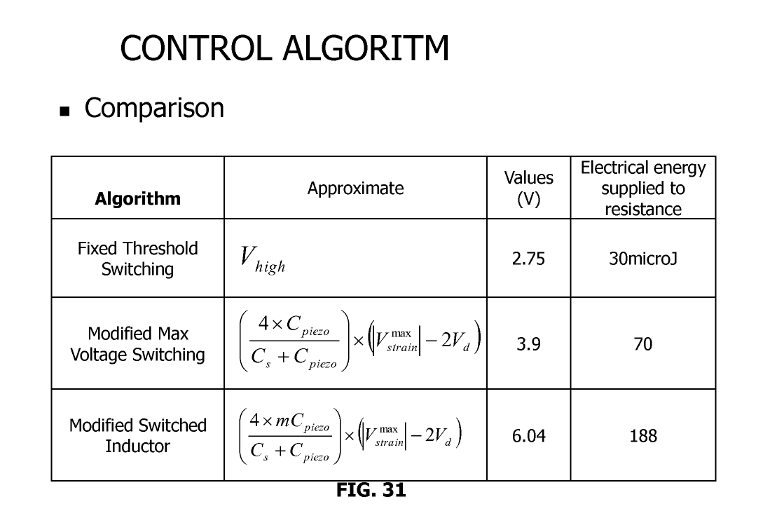

FIG. 31 is a chart comparing three different control algorithms described above with respect to FIGS. 16A-30B.

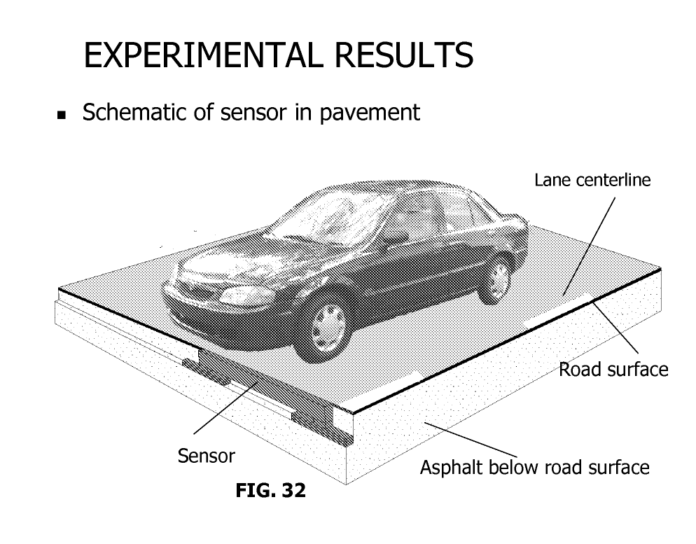

FIG. 32 is a perspective diagram illustrating an example three-layer WIM sensor system embedded into below the roadway surface.

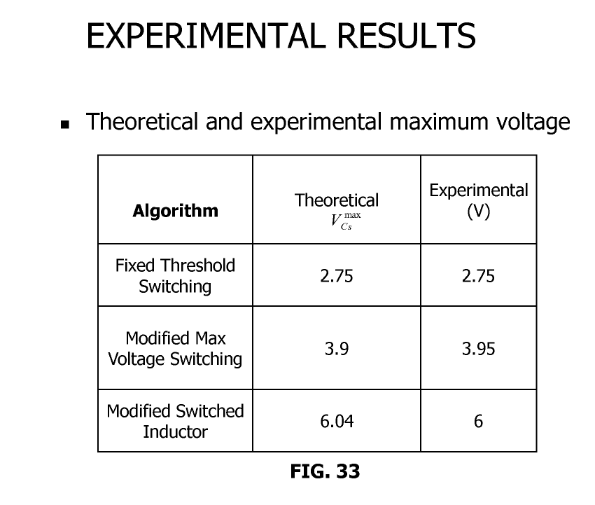

FIG. 33 is a chart comparing theoretical and experimental results for three different control algorithms described above with respect to FIGS. 16A-30B.

FIG. 34A is a slide describing the use of multiple WIM sensors within an example WIM sensor system in accordance with this disclosure.

FIG. 34B is a conceptual diagram illustrating a portable apparatus that carries one or more WIM sensors in accordance with this disclosure.

In some examples, the WIM sensors described herein may include two piezos for each of the beams that are bonded at the locations shown in FIG. 11A and connected electrically in parallel. In such examples, the average of the strain over the area of all the piezos may depend only on the total load acting on the main beam. In such a configuration, the average voltage developed by the piezo would be independent of the locations of the load and the sensor can accurately determined the weight of the passing vehicle.

In some examples, the techniques described herein may be used to perform other measurements in addition to, or in lieu of weight measurements. For example, the speed of the passing vehicle can be measured by measuring the time difference in the loading between two consecutive sensors placed a short longitudinal distance apart. The number of axles on the vehicle is directly available, since each axle provides a load on the sensor and enables one wireless transmission per axle.

Example control algorithms are described in K. Vijayaraghavan and R. Rajamani, ‘Active Control Based Energy Harvesting for Battery-Less Wireless Traffic Sensors: Theory and Experiments, Proceedings of the 2008 American Control Conference, Seattle, Wash., pages 4579-4584, Jun. 11-13, 2008, the entire contents of which is hereby incorporated by reference.

For example, various aspects of the techniques described in this disclosure may be implemented within one or more general purpose microprocessors, digital signal processors (DSPs), application specific integrated circuits (ASICs), field programmable gate arrays (FPGAs), or other equivalent logic devices. Accordingly, the terms “processor” or “controller,” as used herein, may refer to any of the foregoing structures or any other structure suitable for implementation of the techniques described herein.

If implemented in software, the techniques may be realized at least in part by a computer-readable medium comprising instructions or code that, when executed by one or more processors, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), eDRAM (embedded Dynamic Random Access Memory), static random access memory (SRAM), FLASH memory, magnetic or optical data storage media.

The techniques additionally, or alternatively, may be realized at least in part by a computer-readable communication medium that carries or communicates code in the form of instructions or data structures and that can be accessed, read, and/or executed by one or more processors. Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Any software that is utilized may be executed by one or more processors, such as one or more DSP's, general purpose microprocessors, ASIC's, FPGA's, or other equivalent integrated or discrete logic circuitry.

Various embodiments of the invention have been described. These and other embodiments are within the scope of the following claims.

1. An apparatus comprising:
a first beam configured to deform when a load object passes over the apparatus, wherein the first beam exhibits a linear relationship between an amount of deformation and an amount of force applied to the first beam;
a second beam configured to deform when the load object passes over the apparatus, wherein the second beam exhibits a nonlinear relationship between an amount of deformation and an amount of force applied to the first beam;
an energy harvesting circuit configured to harvest energy from deformations of the second beam based on vibrations caused by the load object passing over the apparatus; and
a measurement circuit configured to generate an electrical parameter corresponding to a weight of the load object passing over the apparatus based on an amount of deformation of the first beam.

2. The apparatus of claim 1, further comprising:
a wireless transmission circuit configured to transmit the electrical parameter to a receiving station.

3. The apparatus of claim 2, wherein the energy harvesting circuit is further configured to harvest an amount of energy that is sufficient to power the wireless transmission circuit.

4. The apparatus of claim 1, wherein the energy harvesting circuit comprises at least one piezoelectric element disposed on the second beam.

5. The apparatus of claim 1, wherein the measurement circuit comprises at least one piezoelectric element disposed on the first beam.

6. The apparatus of claim 1, wherein the energy harvesting circuit is further configured to harvest energy from deformations of the first beam and the second beam.

7. The apparatus of claim 1, wherein the measurement circuit is further configured to generate the electrical parameter based on the amount of deformation of the first beam and an amount of deformation of the second beam.

8. The apparatus of claim 1, further comprising:
a third beam configured to apply force to at least one of the first beam and the second beam at one or more fixed locations in response to force applied by the load object to the third beam.

9. The apparatus of claim 8, wherein the third beam has a major axis, and wherein, when the load object passes over the apparatus, the load object crosses the major axis at an unfixed location along the axis.

10. The apparatus of claim 1, wherein a thickness of plates within the first beam is greater than a thickness of plates within the second beam.

11. An apparatus comprising:
a beam configured to deform when a load object passes over the apparatus, wherein an amount of stiffness of the beam increases as an amount of force applied to the beam increases;
a measurement circuit configured to generate an electrical parameter corresponding to a weight of the load object passing over the apparatus;
a wireless transmission circuit configured to transmit the electrical parameter to a receiving station; and
an energy harvesting circuit configured to harvest an amount of energy from deformations of the beam that is sufficient to power the wireless transmission circuit.

12. The apparatus of claim 11, wherein the load object is a vehicle.

13. The apparatus of claim 11, wherein the beam is configured to deform when a vehicle passes over the beam, wherein the vehicle is selected from a set of vehicles of interest, and wherein, when a vehicle within the set of vehicles of interest that has a lowest weight passes over the beam, an amount of deformation is sufficient for the energy harvesting circuit to power the wireless transmission circuit and the measurement circuit.

14. The apparatus of claim 13, wherein the beam does not fail when a vehicle within the set of vehicles of interest that has a highest weight passes over the beam.

15. The apparatus of claim 11, wherein the receiving station comprises a processor that determines a weight of the load object based on the electrical parameter.

16. A system comprising:
a sequence of sensing devices disposed along a measurement surface, wherein each sensing device within the sequence comprises at least one beam that deforms when a vehicle passes over the respective sensing device, a measurement circuit configured to generate a respective electrical parameter corresponding to a weight of the load object passing over the respective at least one beam, and a wireless transmission circuit configured to wirelessly transmit the respective electrical parameter; and
a central station configured to receive electrical parameters from the sensing devices within the sequence of sensing devices, and process the electrical parameters to determine a weight of a vehicle passing over the sequence of sensing devices.

17. The system of claim 16, wherein the central station is further configured to process the electrical parameters to remove errors due to vibrations of the vehicle.

18. The system of claim 16, wherein the central station is further configured to perform spatial filtering on the electrical parameters to determine the weight of the vehicle.

19. The system of claim 18, wherein the spatial filtering comprises at least one of calculating a weighted average of the electrical parameters, calculating a moving average of the electrical parameters, performing a curve fitting algorithm, performing adaptive estimation, and modeling vibrations.

20. The system of claim 16, wherein the central station is further configured to determine a bias of a signal corresponding to the electrical parameters, and to determine the weight of the vehicle based on the bias.

21. The system of claim 16, wherein the central station is further configured to determine an amplitude of a vibration component of a signal corresponding to the electrical parameters to determine a dynamic load due to vibration, wherein a total load on a measurement surface is a sum of a static weight of the load object and the dynamic load due to vibration.

22. The system of claim 16, wherein the measurement surface is portable.

23. The system of claim 16, wherein the measurement surface comprises a ramp.

24. The system of claim 16, wherein the measurement surface is a roadway, and the sensing devices in the sequence of sensing devices are embedded in the roadway.

25. The system of claim 16, wherein the sensing devices within a length between a first sensing device within the sequence of sensing devices and a last sensing device within a sequence of sensing devices is sufficient to capture one cycle of vehicle vibrations.

26. The system of claim 16, wherein the sequence of sensing devices comprises at least four sensing devices.
